(19) United States
(12) Patent Application Publication
(10) Pub. No.: US 2009/0327891 A1
(43) Pub. Date: Dec. 31, 2009

(54) METHOD, APPARATUS AND COMPUTER PROGRAM PRODUCT FOR PROVIDING A MEDIA CONTENT SELECTION MECHANISM

(75) Inventors: Jukka Antero Holm, Tampere (FI); Antti Johannes Eronen, Tampere (FI); Juha Henrik Arrasvuori, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/164,804

(22) Filed: Jun. 30, 2008

(51) Int. Cl. G06F 3/00

(52) U.S. Cl. 715/716

(57) ABSTRACT

A method for providing a media content selection mechanism may include providing for display of a selectable object that is representative of a corresponding physical object associated with media content. The selectable object may be arranged in the display based at least in part on a physical location of the physical object represented by the selectable object. The method may further include determining whether the selectable object correlates to a digital content item and enabling the provision of information corresponding to the digital content item in response to selection of the selectable object.

### TECHNOLOGICAL FIELD

Embodiments of the present invention relate generally to content management and display technology and, more particularly, relate to a method, apparatus and computer program product for providing a media content selection mechanism.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. As mobile electronic device capabilities expand, a corresponding increase in the storage capacity of such devices has allowed users to store very large amounts of content on the devices. Given that the devices will tend to increase in their capacity to create content, store content and/or receive content relatively quickly upon request, and given also that mobile electronic devices such as mobile phones often face limitations in display size, text input speed, and physical embodiments of user interfaces (UI), challenges are created in content management. Specifically, an imbalance between the development of capabilities related to storing and/or accessing content and the development of physical UI capabilities may be perceived.

An example of the imbalance described above may be realized in the context of content management and/or selection. In this regard, for example, if a user has a very large amount of content stored in electronic form, it may be difficult to sort through the content in its entirety either to search for content to render or merely to browse the content. This is often the case because content is often displayed in a one dimensional list format. As such, only a finite number of content items may fit in the viewing screen at any given time. Scrolling through content may reveal other content items, but at the cost of hiding previously displayed content items. Furthermore, finding a particular content item in a list format may be difficult if the artist or title is not known, or if instead the content is known on the basis of a recognizable feature associated with the content (e.g., a picture of the artist, the album cover, a logo, a physical location in a storage bin, etc.).

In order to improve content management capabilities, various organization and presentation techniques have been implemented. In this regard, for example, media galleries have been developed that show various content items organized by genre or alphabetically by title or name of the artist. Media galleries have also been developed that enable users to scroll through media content in which each content item is represented by a corresponding album cover or picture of the artist. However, even these types of galleries often require scrolling through small portions of the overall gallery when the galleries get populated with large amounts of content in various genres. Search engines may also be used to find particular content based on the entry of a query term. As such, current technologies for content management typically do not provide users with the ability to review a varied mix of content (e.g., content across various classes or genres of content) via a single and efficient mechanism. Thus, in some instances, only a minimal or at least partial portion of a collection of content items may be browsed, played or utilized.

Thus, it may be advantageous to provide an improved method of organizing and/or presenting content items, which may provide improved content management for operations such as searching, browsing, playing, editing and/or organizing content.

### BRIEF SUMMARY

A method, apparatus and computer program product are therefore provided to enable providing correlations between stored media content and a physical storage location of an object associated with the stored media content. In particular, a method, apparatus and computer program product are provided that may enable the presentation of selectable objects in a virtual media storage facility in which some of the selectable objects correlate directly with respective tangible or real objects and digital media that correspond to each respective tangible or real object. By selecting one of the selectable objects, the user may enable rendering of the digital media that corresponds with the selectable object. Accordingly, a mechanism for providing an interesting way to present access to digital media based on the configuration of what may be a familiar physical storage mechanism may be provided for enabling improved content management. For example, an exemplary embodiment may provide correlations between digital media and a physical storage apparatus such as a media rack via a virtual media rack.

Embodiments of the invention may provide a method, apparatus and computer program product for employment, for example, in mobile environments. As a result, for example, mobile terminal users may enjoy an improved capability for organizing and/or accessing content.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of an apparatus for enabling media content selection according to an exemplary embodiment of the present invention;

FIG. 3 illustrates an image of an exemplary physical media storage facility according to an exemplary embodiment of the present invention;

FIG. 4 illustrates one compartment of the storage facility of FIG. 3 in accordance with an exemplary embodiment of the present invention;

FIG. 5 illustrates an example of a virtual media rack with selectable objects thereon according to an exemplary embodiment of the present invention;

FIG. 6A shows flowchart of operations that may be controlled by a selection manager according to an exemplary embodiment of the present invention;

FIG. 6B shows flowchart of operations that may be controlled by a selection manager according to another exemplary embodiment of the present invention;

FIG. 7 illustrates an example in which selectable content items are shifted to a more easily readable orientation according to an exemplary embodiment of the present invention; and

FIG. 8 is a flowchart according to an exemplary method for providing a media content selection mechanism according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

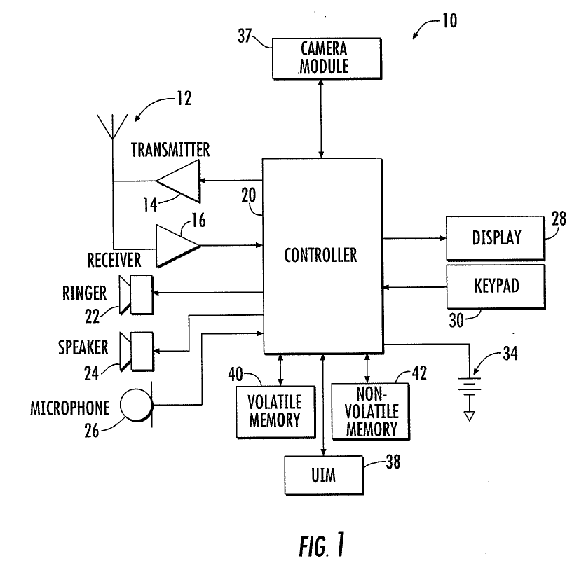

FIG. 1, one exemplary embodiment of the invention, illustrates a block diagram of a mobile terminal 10 that may benefit from embodiments of the present invention. It should be understood, however, that a mobile telephone as illustrated and hereinafter described is merely illustrative of one type of mobile terminal that may benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radio, GPS devices, or any combination of the aforementioned, and other types of communications systems, can readily employ embodiments of the present invention.

In addition, while several embodiments of the method of the present invention may be performed or used by or in connection with a mobile terminal 10, the method may be employed by or used in connection with devices other than a mobile terminal (e.g., personal computers (PCs), servers, or the like). Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

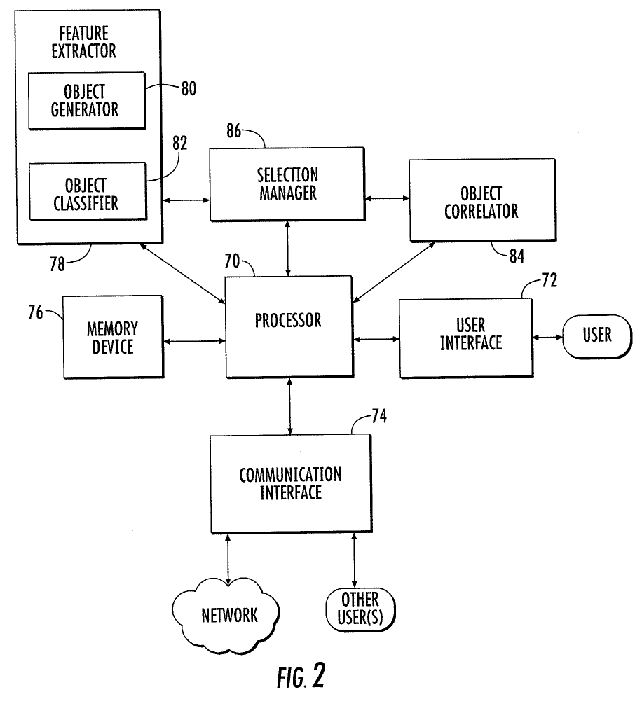

The mobile terminal 10 may include an antenna 12 (or multiple antennas) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved—universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing, among others, audio and logic functions of the mobile terminal 10. For example, the controller 20 may comprise a digital signal processor device, a microprocessor device, and various analog to digital converters, digital to analog converters, and/or other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For, example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication.

In an exemplary embodiment, the mobile terminal 10 may include a media capturing module, such as a camera, video and/or audio module, in communication with the controller 20. The media capturing module may be any means for capturing an image, video and/or audio for storage, display or transmission. For example, in an exemplary embodiment in which the media capturing module is a camera module 37, the camera module 37 may include a digital camera capable of forming a digital image file from a captured image. As such, the camera module 37 may include all hardware, such as a lens or other optical device, and software necessary for creating a digital image file from a captured image. Alternatively, the camera module 37 may include only the hardware needed to view an image, while a memory device of the mobile terminal 10 stores instructions for execution by the controller 20 in the form of software necessary to create a digital image file from a captured image. In an exemplary embodiment, the camera module 37 may further include a processing element such as a co-processor which assists the controller 20 in processing image data and an encoder and/or decoder for compressing and/or decompressing image data. The encoder and/or decoder may encode and/or decode according to a JPEG (Joint Photographic Experts Group) standard format or other formats.

An exemplary embodiment of the invention will now be described with reference to FIG. 2, in which certain elements of an apparatus for enabling media content selection are displayed. It will be appreciated, however, that embodiments of the invention are not limited to enabling media content selection and indeed embodiments of the invention may enable the selection of any kind of content, including non-media content. Accordingly, where “media content” is used herein, it is merely for purposes of example and embodiments of the invention may be applied to other types of content as well. The apparatus of FIG. 2 may be employed, for example, on the mobile terminal 10 of FIG. 1. However, it should be noted that the apparatus of FIG. 2, may also be employed on a variety of other devices, both mobile and fixed, and therefore, the present invention should not be limited to application on devices such as the mobile terminal 10 of FIG. 1. Alternatively, embodiments may be employed on a combination of devices including, for example, those listed above. Accordingly, embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 2, an apparatus for enabling media content selection is provided. The apparatus may include or otherwise be in communication with a processor 70, a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit) or an FPGA (field programmable gate array). In an exemplary embodiment, the processor 70 may be configured to execute instructions stored in the memory device 76 or otherwise accessible to the processor 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a mobile terminal (e.g., the mobile terminal 10), the user interface 72 may include, among other devices or elements, any or all of the speaker 24, the ringer 22, the microphone 26, the display 28, and the keyboard 30.

In an exemplary embodiment, the processor 70 may be embodied as, include or otherwise control a feature extractor 78, an object generator 80, an object classifier 82, an object correlator 84 and/or a selection manager 86. The feature extractor 78, the object generator 80, the object classifier 82, the object correlator 84 and the selection manager 86 may each be any means such as a device or circuitry embodied in hardware, software or a combination of hardware and software that is configured to perform the corresponding functions of the feature extractor 78, the object generator 80, the object classifier 82, the object correlator 84 and the selection manager 86, respectively, as described below.

In an exemplary embodiment, the feature extractor 78 may be in communication with the camera module 37 to receive image data for images captured by the camera module 37. As such, the feature extractor 78 may be configured to extract features from the image data using known image processing techniques. For example, the feature extractor 78 may be configured to perform pattern recognition by employing an algorithm or analysis method for identifying patterns (e.g., related to colors, color distribution, characters, texture, shape, or the like). The feature extractor 78 may also or alternatively be configured to perform image segmentation to separate objects within an image from the background or distinguish between particular objects within the image. In this regard, for example, the feature extractor 78 may be configured to employ threshold techniques, edge-based methods, region-based methods, connectivity preserving relaxation methods or other like techniques to identify and/or separate particular objects within the image data. The feature extractor 78 may also be configured to perform digital character recognition and/or optical character recognition (OCR) to, for example, translate images (or portions of images) including handwritten or typewritten text into machine-readable or editable text. Alternatively, OCR may be used to translate pictures of characters into a standard encoding scheme to represent the characters (e.g., Unicode or ASCII).

Thus, according to an exemplary embodiment, the feature extractor 78 may be configured to utilize a scanning capability and computer algorithms or other software or hardware related mechanisms to extract feature data from a given image for identifying particular objects within the given image and also for identifying text, images or other determinable features corresponding to each of the particular objects. As such, for example, the feature extractor 78 may be configured to utilize image data from a picture taken of an actual storage rack or shelf that includes storage cases, covers or other indicia related to physical representations or tangible media corresponding to media content (e.g., a book cover, a compact disc (CD) case, an album cover, a digital video disc (DVD) or the like). In other words, for example, the feature extractor 78 may be configured to identify objects in an image and segment the image accordingly. The feature extractor 78 may also be configured to enable the recognition of characteristics or text related to each (or at least some) of the identified objects.

In some embodiments, rather than performing feature extraction based on image data received from a collocated camera module 37, the feature extractor 78 may perform feature extraction based on image data received from a remote camera or from a storage location (e.g., the memory device 76). Thus, the image need not be a recently taken or new image, but may instead be an image that has been stored for any length of time.

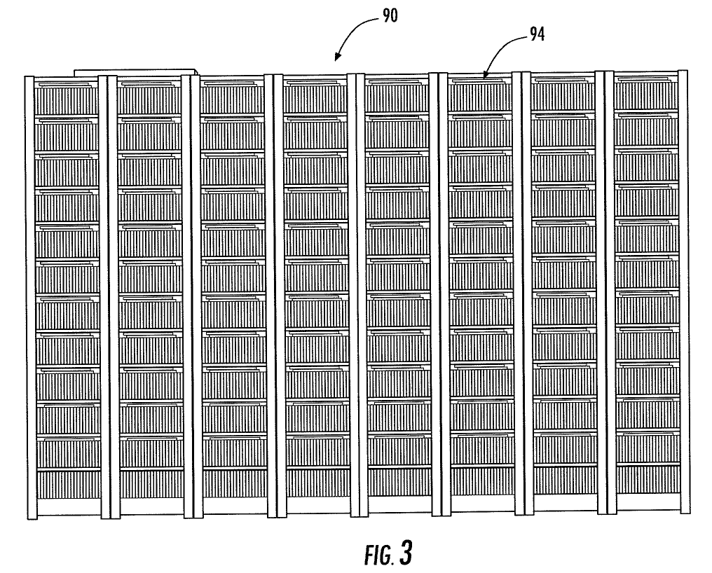

In an exemplary embodiment, the feature extractor 78 may include or be in communication with an object generator 80 and/or an object classifier 82 for the performance of certain functions associated with the feature extractor 78. Thus, although FIG. 2 shows the object generator 80 and the object classifier 82 being respective portions of the feature extractor 78, either or each of the object generator 80 and the object classifier 82 may alternatively be separate devices or components. In some cases, the object generator 80 may be configured to utilize feature data extracted from the image data to generate one or more objects based on the objects recognized from the extracted feature data. As such, for example, the feature data, which may be received from the feature extractor 78, may indicate a plurality of similar sized objects (e.g., CD cases) stacked within different compartments or shelf segments of a book case, media rack, shelving structure or the like. FIG. 3 shows an example of storage apparatus in the form of a media rack 90 with a plurality of compartments 92, each of which holds a plurality of CD cases therein. However, it should be understood that the CD media rack of FIG. 3 is merely exemplary and any shape or configuration for a storage apparatus for the storage of any type of media may be used with alternative embodiments.

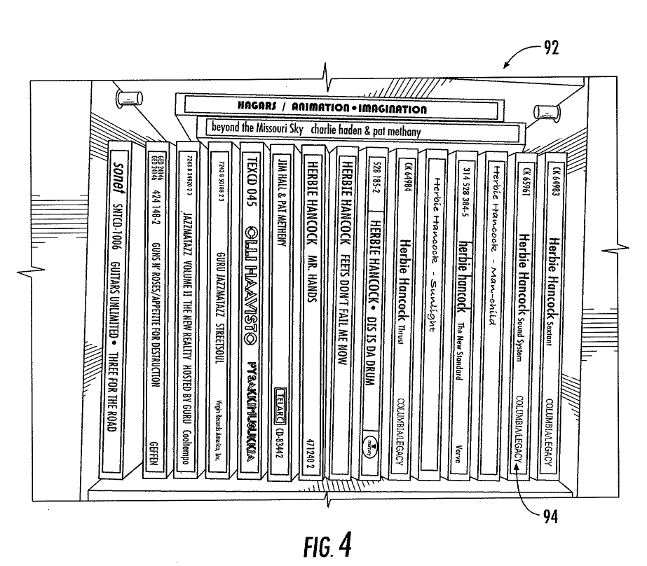

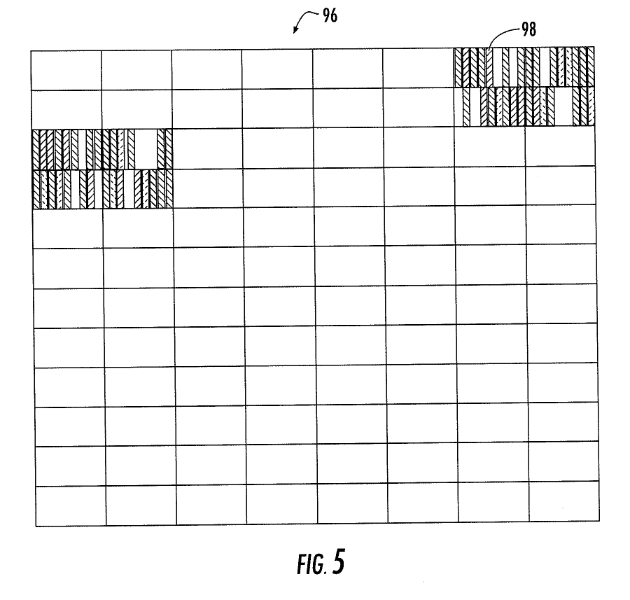

In an exemplary embodiment, the object generator 80 may be configured to generate a displayable object corresponding to the identified or segmented objects from the image data. Thus, for example, given the image of FIG. 3, the feature extractor 78 may extract features from the image related to texture, text (e.g. media title data, which may, for example, be extracted through optical character recognition or the like), color, patterns, and/or the like and communicate such features to the object generator 80, which may utilize the extracted features to recognize the configuration of the shelving upon which the CD cases are stored and/or recognize the configuration of, and presence of, the CD cases themselves on the shelving. The object generator 80 may thereafter construct a virtual shelf or media rack 96 having similar characteristics to those of the actual shelving recognized from the image. FIG. 4 shows an example of a portion of the media rack of FIG. 3 illustrating one compartment 92 holding a plurality of objects 94. FIG. 5 shows an example of a construction of the virtual shelving or media rack corresponding to the shelving in the image of FIG. 3.

In this regard, as shown in FIG. 5, the object generator 80 may be configured to determine the number and/or placement of individual shelves or compartments within a media rack based on the feature data provided by the feature extractor 78 and construct the virtual media rack 96 to have an equivalent number and configuration of shelves or compartments. Thus, the 8 by 12 arrangement of shelves pictured in FIG. 3 may be duplicated by the object generator 80 in the virtual media rack 96 of FIG. 5. In some embodiments, the user may be requested to confirm the determined arrangement by being presented with a display of the virtual media rack 96 generated based on the extracted features along with a query as to whether the presented display is correct. In alternative embodiments, the user may directly enter information regarding the configuration of a physical shelving apparatus either to supplement or correct a generated virtual media rack, or to be used as the basis for generating a virtual media rack. Thus, in at least one embodiment, the virtual media rack may be generated by the object generator 80 based on user input rather than based on extracted features from an image.

The object generator 80 may also be configured to determine the number and/or placement of individual objects (e.g., CD cases) on each shelf or in each compartment based on feature data from the feature extractor 78. Thus, for example, the object generator 80 may be configured to generate a number of rectangles having sizes that approximate or are similar to the size of the individual objects (e.g., selectable objects 98) as compared to the space associated with the physical shelving relative to the space defined for each generated virtual shelf or compartment of the virtual media rack. Accordingly, the object generator 80 may generate an approximation or representation of an existing physical shelf or other storage facility in the form of the virtual media rack 96.

In an exemplary embodiment, the object generator 80 may be further configured to enable the user to modify aspects of the generated virtual shelving. Thus, for example, the user may be enabled to modify shelf or partition width, coloring, texture or other features. The arrangement of the shelving, or of the contents on the shelving, could also be modified based on user input. Thus, for example, if the contents on the shelving represent the spines of CD or DVD cases arranged to stand on the shortest side of their respective cases, the object generator 80 could be configured to present the cases instead so that the cases rest on one of their longest sides (e.g., to make the text on the case more readable).

The object classifier 82 may be configured to analyze feature data (e.g., from the feature extractor 78) that may be related to the performance of optical character recognition (OCR) or other recognition techniques on, for example, text written on one or more of the individual objects on the shelves in order to generate text, colors, graphics, or other indicia for labeling, identifying or otherwise classifying the objects. In an exemplary embodiment, object data determined regarding a particular object may be correlated with known or accessible (e.g., via the Internet or a local or remote database) information associated with media of the same type or class as the physical media stored on the shelving in the image. As such, for example, the name of a particular album or movie may be recognized by OCR from the CD or DVD spine and the object classifier 82 may access the Internet or a database to determine information about the album or movie to assist in recognition of the album or movie. For example, the genre of the album or movie, the artist or actors of the album or movie, release dates, production company, biography information, related links, album or movie cover graphics, logo information, and/or the like may be determined by the object classifier 82. In some embodiments, the object classifier 82 may be configured to compare features extracted from an image to a feature database including, for example, images or image features for various albums, movies, books or other media in order to correlate image features from the image data presented to a stored image or features. Thus, a particular object may be associated with a particular artist, author or other media source and classified accordingly.

As yet another alternative, the object classifier 82 may be configured to compare image features such as color histograms extracted from the image of an object such as the spine of a movie, album or book against album cover images stored in association with accessible digital media or retrievable in connection with the accessible digital media. As an example, image features measured from album spines can be compared against album cover images associated with digital music files stored on the user's device (or another accessible location). Thus, for example, if the user has stored content (e.g., songs) from one of the user's personal media storage devices (e.g., a CD) in digital format, the user may have also stored corresponding album cover images that may be used for matching purposes, which could make the matching process faster and more reliable in some instances. In one embodiment, the use of color histograms or other techniques (e.g., measuring the shape, color, curvature or other characteristics of characters that are visible on the object) may be implemented in the event that no text can be read from a particular object (e.g., either because there is no text or because the text is difficult to read or analyze). In some cases, the segmented image portion corresponding to a particular object that cannot be classified or is classified with a relatively low confidence level may be checked against a database of objects. Thus, for example, a picture of the album spine of an unclassified object may be analyzed against a database of album spines to determine the identity of the album spine or candidate album spines that may correlate to the album spine of the picture. For example, a database of album spines may be located on a server and image features may be sent to the server to be correlated against known spine images. The results of the comparison may then be communicated back to the user's device. Thus, in various exemplary embodiments, image capture, analysis (e.g., comparisons, correlations, etc.), and generation of data corresponding to the results of the analysis may be all done at one device (e.g., a mobile terminal) or may be split between different devices (e.g., camera takes picture, server analyzes and mobile terminal displays results). In one embodiment, the object classifier 82 may be configured to prompt the user to enter album title if the identity of the album spine may not be correlated with candidate album spines, such as because of image quality. In this regard, a user may be presented with a plurality of candidate albums that may correlate with the album spine and the user may select the correct album from the presented plurality of likely candidate albums. The object classifier 82 may be configured to prompt the user for input in such an embodiment if the likelihood of an accurate correlation is below a predefined threshold. Other arrangements are also possible.

Additionally or alternatively, the object classifier 82 may be configured to compare image feature data extracted from the image of one or more objects, such as the spine(s) of one or more movies, albums, or book(s) to a data source comprising information about one or more physical objects depicted in the image data. In this regard, the data source may comprise, for example, a list, database, spreadsheet, or the like. The data source may comprise data identifying physical objects in the image data, such as, for example, a list of album titles, movie titles, album cover images, and/or movie cover images. The data source may be locally stored or remotely accessed and may, for example, be provided by a user. In this regard, the object classifier 82 may be configured to access the data source in addition to and/or in lieu of accessing information via the internet or other network.

The object classifier 82 may then associate some or all of the determined information with a respective object and communicate the associated information to the object generator 80. The object generator 80 may then modify a selectable object generated to act as a virtual representation of the particular object to include some or all of the information determined by the object classifier 82 or to provide a mechanism by which to access such information (e.g., via an icon or link to such information). In some embodiments, the object classifier 82 may maintain a database of classified objects, corresponding selectable objects generated responsive to each classified object and any supplemental information or information indicative of a location of the supplemental information associated with a classified object.

In an exemplary embodiment, as indicated above, the object generator 80 may be configured to provide for the display of objects determined as selectable objects. Each selectable object may be a graphic or display element providing a virtual representation associated with a respective physical object (e.g., book, CD case, DVD case, etc.) that may be presented in the virtual media rack. Information on each selectable object may be either displayed on or in association with the respective selectable object. In some cases, the information may be partially displayed on the selectable object (e.g., title information) while other portions of the information (e.g., details regarding album or movie cover, related links, release date, biography information, etc.) may be accessible by selection of the selectable object, by selection of an information icon associated with the selectable object, or merely by scrolling over the selectable object.

In an exemplary embodiment, as shown, for example, in FIG. 5, selectable objects 98 may be color coded or distinguished in some other fashion on the basis of genre or other classifications. As such, for example, if the objects on the shelves happen to be mixed contents (e.g., music, books and movies) some content (e.g., books) may have a particular color associated therewith, while other content (e.g., movies or CDs) may have a different color associated therewith. In examples where genre is used to further distinguish classifications of the objects, the selectable objects associated with one genre (e.g., rock music) may have a particular color or other characteristic while selectable objects associated with another genre (e.g., country music) may have a different color or characteristic associated therewith. Sub-genres (e.g., within metal music, sub-genres may include speed metal, power metal, thrash metal, etc.) may also have different colors or characteristics associated with each sub-genre. In some cases, the characteristics may include a combination of colors, shapes, characters, icons, or other indicia to enable differentiation between genres and sub-genres. For example, a colored square displayed on a selectable object may indicate the sub-genre associated with the media content represented by the corresponding selectable object while the color of the object itself (or some other shape on the object) may be indicative of the genre of the selectable object.

As further shown in FIG. 5, the compartments or portions of the virtual media rack 96 may be populated incrementally with selectable objects 98. In some cases, more detailed pictures may be taken of each compartment or of groups of compartments until a picture of sufficient detail is obtained to permit feature extraction, classification and correlation as described herein. In some cases, the user may be prompted incrementally to take such pictures until all compartments are covered. However, in other embodiments, the user may only be prompted to take pictures of compartments or regions that are not currently represented or not sufficiently represented.

In an exemplary embodiment, the apparatus may include the object correlator 84, which may be configured to make correlations between the physical object in an image, which may have already been associated with information accessible about the physical objects on the basis of the features extracted from the image by the object classifier 82, and a stored digital media content item. As such, for example, the object correlator 84 may be configured to determine whether the apparatus has either stored a digital media file corresponding to the respective physical object or has access to such a file. The object correlator 84 may then provide a link or other correlating mechanism to bind selectable objects, which are placed by the object generator 80 at locations corresponding to the location of corresponding physical objects in a physical shelving assembly, with information indicative of a location of the digital media that corresponds to each respective selectable object. In situations where a recognized selectable object does not correspond to any accessible digital media, the object correlator 84 may not be able to make a correlation and may communicate such fact to the object generator 80. The object generator 80 may then be configured to generate some indicia on or associated with the recognized selectable object to indicate that no digital media is available for the object. As such, the user may be reminded that the user has not yet transferred the media content associated with the corresponding object in the image into a digital media file.

In practice, the physical objects on the shelving may be CDs, DVDs or other media that may be transferred or converted into digital media files to enable electronic devices such as mobile telephones, mobile computers or other mobile media playing devices to render the digital media files without requiring the CDs or DVDs themselves. It is becoming common for users that possess large CD, DVD or other media collections to convert such collections into stored digital media content items accessible via their respective mobile devices. Thus, embodiments of the present invention may enable a direct mapping between the cases or other objects associated with a media collection and stored media files that may be associated therewith or even may have originated therefrom. Embodiments of the present invention may enable the extraction of information to generate a template for a virtual media rack with virtual media objects (e.g., the selectable objects) stored on the virtual media rack in positions that correspond to the actual physical location of the corresponding physical objects in an actual shelving assembly based on an image of the actual shelving assembly. In this regard, as indicated above, the feature extractor 78 may extract feature data from the image, the object generator 80 may generate the virtual media rack with selectable objects positioned in the virtual media rack at respective appropriate locations based on the feature data and based on classification data determined by the object classifier 82. In this regard, for example, a user may use an arrangement of real life media racks to generate one or more virtual media racks representing tailored playlists, such as, for example, a playlist of favorite albums. Accordingly, multiple pictures of real life media racks can be used to generate multiple virtual media racks, each of which may represent a genre of media and/or other user-defined categorization based upon the real life arrangement of the one or more media racks. The object generator 80 may also provide information or indicia indicative of detailed related information determined to be associated with each selectable object. The object correlator 84 may then correlate an identified object to a stored file or files that may be associated with respective ones of the selectable objects so that if a selectable object is selected, the stored file or files may be rendered or information associated therewith may be presented to the user.

In an exemplary embodiment, the apparatus may also include the selection manager 86. The selection manager 86 may be configured to manage overall flow of the operations involved in generating and/or updating virtual shelving in accordance with exemplary embodiments of the present invention. As such, for example, the selection manager 86 may be configured to, among other things, respond to user selections by interfacing with any or all of the feature extractor 78, the object generator 80, the object classifier 82 and/or the object correlator 84 to provide information to the user via a display of options for selection or information returned responsive to a selection or other user activity. As such, for example, in response to selection of a selectable object, the selection manager 86 may retrieve information stored in association with the selectable object for presentation of the retrieved information to the user. Alternatively, the selection manager 86 may be configured to perform an action based on the selectable object that is selected. For example, the selection manager 86 may be configured to retrieve the stored file or files associated with a selected selectable object to enable the initiation of or actually initiate the rendering of the stored file or files. With respect to enabling the initiation of file rendering, the selection manager 86 may provide interface and control options such as a play, stop, rewind, fast forward, next, previous, or other related commands to the user for further selection.

In some embodiments, the selection manager 86 may also provide for an interface between one or more of the feature extractor 78, the object generator 80, the object classifier 82 and/or the object correlator 84 and the user (e.g., via communication with the user interface 72) to provide options to the user and/or receive selections from the user related to optional functions that may be associated with one or more of the feature extractor 78, the object generator 80, the object classifier 82 and/or the object correlator 84, respectively. For example, the selection manager 86 may be configured to interface between the user and the feature extractor 78 with respect to soliciting further image collection to ensure adequate image quality for enabling sufficient feature extraction. In this regard, for example, the feature extractor 78 may analyze image data to determine whether the quality of the image associated therewith is sufficient to enable a determination with respect to shelf configuration and/or object determination. For example, if the image is blurry, low resolution, incomplete, unreadable, unstable, has poor lighting, or the like, the feature extractor 78 may provide an indication to the selection manager 86 to enable the selection manager 86 to solicit further input (e.g., additional or better images) from the user until sufficient a quality, size or quantity of image(s) have been obtained.

Thus, the selection manager 86 may serve as a mechanism by which embodiments of the present invention are initiated or managed by the user, or by which information associated with the initiation or management of such embodiments is communicated to the user. In some cases, a menu option or icon may be selectable by the user to enable, initiate or access virtual shelving setup, display, object selection and/or other functionalities. As such, for example, selection of the menu option or icon may cause the selection manager 86 to initiate operations to collect data for generation or updating of virtual shelving. In some embodiments, the selection manager 86 may provide intermediate feedback to the user regarding classifications made, correlations made, templates for virtual media racks and other like determinations made by various devices or components of the apparatus and the user may verify the determinations made or manually change or modify the determinations.

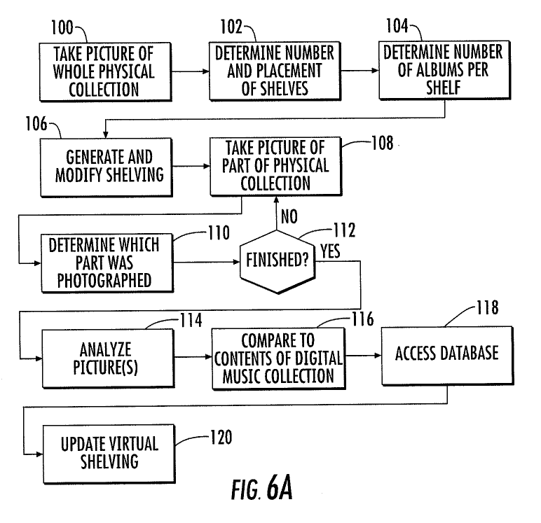

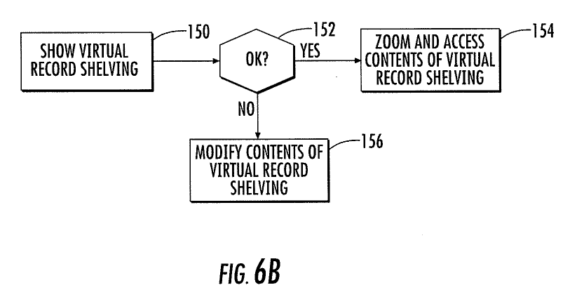

FIG. 6A shows an example of various operations that may be controlled by the selection manager 86 with respect to performance of one embodiment of the present invention. In this regard, as shown in FIG. 6A, the user may take a picture of a whole physical collection at operation 100. The taking of the picture may be, in some embodiments, a mechanism to trigger operation of the selection manager 86. However, in an alternative embodiment, the taking of the picture may be a response to a request from the selection manager 86. As another alternative, the picture may have been taken in the past and the selection manager 86 may, for example, after a user instruction to initiate virtual shelving generation, retrieve the previously taken picture for communication to the feature extractor 78. At operation 102, a determination may be made as to the number and placement of shelves in the picture (e.g., by the object generator 80 based on the feature data or user input). The number of objects (e.g., albums) per shelf may be determined at operation 104 and virtual shelving may be generated at operation 106. Both operations 104 and 106 may again be performed by the object generator 80. In an exemplary embodiment, the selection manager 86 may interface with the user to receive or solicit information related to modifications to the virtual shelving or the objects thereon also at operation 106. For example, the selection manager 86 may solicit information regarding user preferences with respect to display options such as shape, color, text font, or other presentation options.

In an exemplary embodiment, information from the feature extractor 78 may be utilized to determine whether the current picture or pictures are sufficient to enable the object classifier 82 to classify the objects in the picture(s). If more or clearer pictures are needed, the need for such pictures may be communicated to the selection manager 86 and the selection manager 86 may solicit additional pictures so that additional pictures of parts of the physical collection may be taken at operation 108. In some cases, the selection manager 86 may merely indicate that more pictures are desired. However, in some embodiments, the selection manager 86 may provide further instructions as to which portions are adequate and/or which portions need pictures taken or replacement pictures taken. After a picture of a portion of the physical collection has been received, the selection manager 86 may direct that a determination be made with respect to which portion of the physical collection has been made (e.g., by the object classifier 82) at operation 110. In this regard, queues may be found in each picture as to how such picture relates to the overall picture of the physical collection or to adjacent pictures of portions of the physical collection. A determination may be made as to whether complete data has been received (e.g., whether clear and/or readable pictures enabling generation of the selectable objects in all portions of the physical collection) at operation 112. If complete data is received, further picture analysis may be performed at operation 114. However, if complete data is not received, operations 108 through 112 may be repeated until complete data has been gathered.

The picture analysis at operation 114 may include operations by the object classifier 82 with respect to conducting OCR or other operations to identify objects (e.g., by reading text on the spine of a CD case, DVD case or other media case) within the picture to enable labeling or the provision of descriptive information to be associated with selectable objects. At operation 116, the contents of a digital music collection may be compared to information determined regarding a classified object (e.g., by the object correlator 84) in order to attempt to correlate an identified object to stored digital media for enabling mapping of stored digital media against a virtual representation of a physical storage location of the identified object. The comparison may involve accessing a database at operation 118 to retrieve information associated with a classified object. Selectable objects may be provided on the virtual shelving at locations based on the location of the corresponding physical object on the corresponding physical shelving. At operation 120, the selection manager 86 may direct updating of information and/or graphics associated with the virtual shelving and the selectable objects displayed thereon.

In some embodiments, the selection manager 86 may also be employed to rearrange selectable objects or modify (or correct) information associated with the selectable objects (e.g., artist, album name, movie title, etc.). In an exemplary embodiment, the selection manager 86 may provide the user with various arrangement options such as sorting options for sorting selectable objects based on various metadata or characteristics (e.g., alphabetical listings by artist, album name, movie title or the like, by genre, by production company or year, by year purchased, by frequency of play, by most recent play, etc.). FIG. 6B illustrates an example of a flowchart for modification of virtual media rack and/or selectable objects according to one embodiment. In this regard, as shown in FIG. 6B the user may be presented with a current display of virtual shelving and/or objects at operation 150. In some cases, the selection manager 86 may present options or queries to the user to solicit feedback on changes that the user may desire in order to determine whether the user considers the current display to be acceptable at operation 152. However, as an alternative, the user may initiate the entry of such feedback in an unsolicited manner. If the user indicates that the current display of virtual shelving and/or objects is acceptable, further user selections may relate to zooming, panning or otherwise altering the portion of the virtual media rack that is viewed or in focus, or may relate to accessing digital media items that correspond to the selectable object that is selected at operation 154. Meanwhile, if the user indicates that the current display is unacceptable, the user may be presented (e.g., by the selection manager 86) with options or instructions for modifying the contents or configuration of the virtual shelving at operation 156.

Thus, in an exemplary embodiment, the selection manager 86 may also respond to user selections with different responses based on the context in which a user input has been provided. For example, in addition to the modification discussion provided above, the virtual media rack may be presented in a manner that provides different selection interaction modes in dependence upon the zoom level at which the user is currently viewing the media rack. In this regard, if a full view or nearly full view of the media rack is presented, a user selection (e.g., via mouse, cursor, touch screen input or the like) of a particular region may result in a zoom in to an area around the selected region. For example, zooming into an area around the selected region may result in a digital representation of a region such as a digital representation of the region of the real-life media rack illustrated in FIG. 4 as opposed to a digital representation of the full real-life media rack illustrated in FIG. 3. Once the user has zoomed in to a particular threshold level, further selections may be recognized as an attempt to selection a selectable object corresponding to the selected location. As an alternative, selections made to regions corresponding to selectable objects may always be interpreted as selections of the corresponding selectable objects, while selections of portions of the media rack itself may be interpreted as zoom or pan related selections. In still other alternative embodiments, selectable function operators may be presented to the user to change the function of each selection to be subsequently made by the user. In some cases, each time the user zooms in on a particular area, more detailed information regarding the content (e.g., the selectable objects) in the zoomed in area may be presented. Thus, rather than selecting an icon or link to further information about a selectable object, the user may merely continue to zoom in on the object until the level of detailed information desired has been displayed. In some cases, although the selectable object may be presented initially as a representation of the spine (e.g., a pictorial representation of the actual spine or a representation of information associated with the spine including either vector graphics, shapes and patterns based on the actual spine or an image of the actual spine) of a media object (e.g., a CD case), upon zooming in to a particular level, a representation of the front and/or back cover of the CD case may be provided.

As indicated above, different color schemes or other differentiating characteristics may be applied to the selectable objects. For example, special indicia may be applied to selectable objects based upon the frequency, the number of times, and/or how recently a selectable object has been selected. For example, selectable objects that have been selected below a threshold frequency or were not selected in a period of time (e.g. the previous 60 days) may be faded. Alternatively, selectable objects that have not been selected frequently or have not been selected to recently may be highlighted, which may facilitate to draw them to the attention of a user. Additionally or alternatively, selectable objects that have been selected recently or have been selected frequently may be faded. It will be appreciated that “fading” is just one example of a special indicia that may be applied based upon such criteria and other special indicia may be applied based upon these or other criteria. Special indicia may further be provided to distinguish selectable objects that do not correlate to stored media. As indicated above, in an exemplary embodiment, selection of a selectable object that corresponds to stored digital media may enable the rendering of the stored digital media. However, in some cases, selection of a selectable object that does not correspond to any stored media may result in the provision of information indicating that no corresponding media is available, or may provide a link to an online music store to enable downloading of content associated with the selectable object. Links may also be provided after selecting a selectable object that is correlated to stored digital media. In this regard, such links may be to further information, goods or services associated with the stored digital media. In some cases, the selection manager 86 may be further configured to provide recommendations to the user regarding content related to selectable objects. The recommendations may be received from, for example, an online service. In other embodiments, the selection manager 86 may insert blank spaces in the virtual media rack for missing albums from an artist collection, missing movies from a trilogy or other movie collection, or missing books from a series or provide reminders to the user about upcoming release dates for new media that may be of interest to the user.

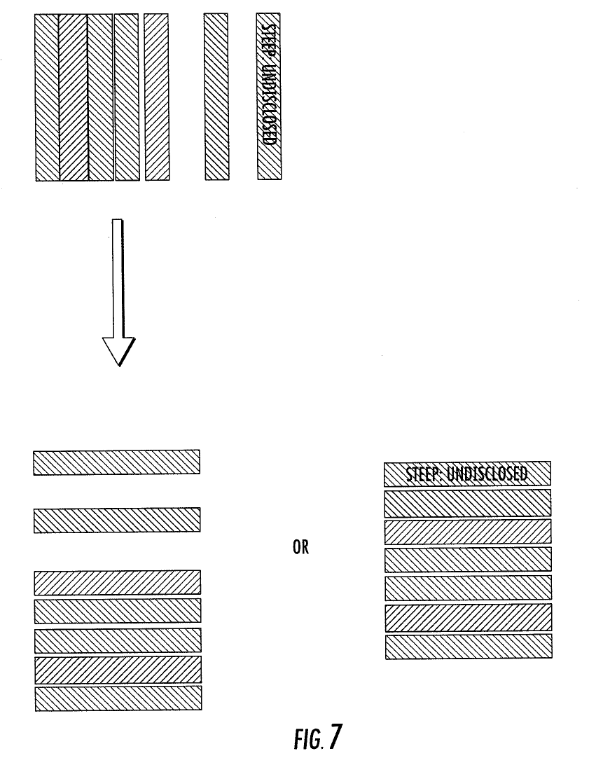

Various other extensions and/or embellishments may also be added. For example, in one embodiment, in response to the selection manager 86 detecting the selection of a particular content item corresponding to a selectable object (e.g., an album case), the selection manager 86 may communicate with the object generator 80 so that the object generator 80 may generate graphics corresponding to the placement of a CD into a virtual media player. In some cases, the representation of the CD being placed into the virtual media player may include the same or similar labeling to that of the actual physical CD. As indicated above, the selectable objects may be sorted or modified according to user input. Thus, for example, as shown in FIG. 7, which illustrates an example in which selectable content items are shifted to a more easily readable orientation (e.g., with text extending horizontally instead of vertically), the selection manager 86 may receive or solicit user input that may be communicated to the object generator 80 (or other components) to influence the display properties of the selectable objects. It will be appreciated that FIG. 7 is just one example of sorting or modifying the selectable objects. In another example, selectable objects, such as representations of CDs may be pivoted at least partially about a vertical axis so as to display more graphical information. For example, the physical object and accordingly the digital representation (e.g. the selectable object) may be contained in a rack such that the CD's spine is displayed to a user. However, the selectable object may be pivoted at least partially so that at least part of the CD's front album cover art is displayed so that a user may more easily recognize a selectable object.

Accordingly, in addition to providing a clear mapping between the user's physical and virtual record collections, embodiments of the present invention may also enhance the user's experience in searching, selecting and rendering digital media. In some cases, the user may be eliminating or reducing the size of their physical collection (e.g., due to moving into temporary lodging or a smaller apartment). In such a situation, embodiments of the present invention may enable the user to create a virtual record of the old and possibly very familiar arrangement to enable continued access to media from the collection in a familiar manner. Furthermore, embodiments need not necessarily only be practiced in the context of a single user mapping his or her personal digital media library to his or her corresponding physical storage apparatus. Instead, a user may map their own digital content against another person's (e.g., a friend's) physical media collection simply by taking one or more pictures of the other person's shelving. Other extensions of embodiments of the present are also possible. For example, a user's collection of books, movies, computer games, music and/or other media may be located on physical shelving and embodiments of the present invention may be utilized to create a personalized view to a media Web service or service platform. In this regard, the media may be located on physical shelving in a certain order so that, for example, the music disks are on top, books and movies are in the middle, and computer games are on the bottom. The user may take a picture of the physical shelf, and then send this image to the service platform to be used for personalizing the user's service view. In an exemplary embodiment, analysis of the picture pr pictures may be performed on the servers of the service platform to determine the locations of music, books, movies, and computer games in the user's physical shelving, and then to adjust the user interface shown in a Web browser accordingly when the user logs into the service in the future. For example, the Web UI of the service platform may adapt for this user to show a link to the music shop on the top, book shop and movie shop in the middle, and computer games on the bottom. Alternatively, the user might take a picture of his room, and a three dimensional virtual representation of the user's room might be created to be used as a UI for the service platform. Thus, individual media objects need not necessarily be attached to the virtual representation, but may be instead used for personalizing the UI that is used to access a media service or service platform.

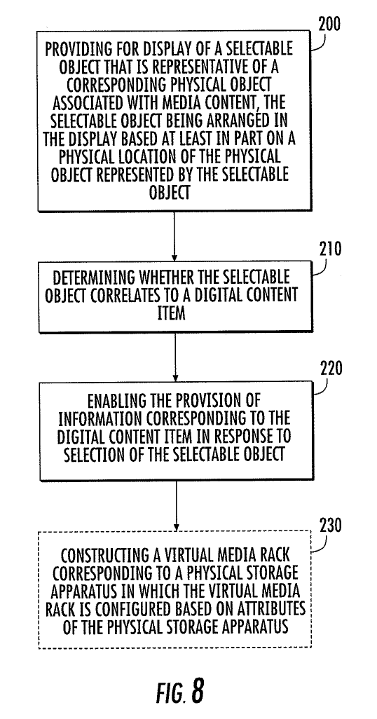

FIG. 8 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or other apparatus employing embodiments of the present invention and executed by a processor in the mobile terminal or other apparatus. As will be appreciated, any such computer program instructions may be loaded onto a computer or other programmable apparatus (i.e., hardware) to produce a machine, such that the instructions which execute on the computer (e.g., via a processor) or other programmable apparatus create means for implementing the functions specified in the flowchart block(s) or step(s). These computer program instructions may also be stored in a computer-readable memory that can direct a computer (e.g., the processor or another computing device) or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing media content selection as illustrated, for example, in FIG. 8 may include providing for display of a selectable object that is representative of a corresponding physical object associated with media content at operation 200. The selectable object may be arranged in the display based at least in part on a physical location of the physical object represented by the selectable object. The method may further include determining whether the selectable object correlates to a digital content item at operation 210 and enabling the provision of information corresponding to the digital content item in response to selection of the selectable object at operation 220.

In an exemplary embodiment, the method may include further optional operations as well. For example, an exemplary additional operation may include operation 230 (which is shown in dashed lines) of constructing a virtual media rack corresponding to a physical storage apparatus (e.g., a media rack, shelf or shelving complex) in which the virtual media rack is configured based on attributes of the physical storage apparatus. In such an embodiment, the selectable object may be one of a collection of selectable objects in which each of the selectable objects is associated with each respective one of a plurality of physical objects stored in the physical storage apparatus. In this regard, constructing the virtual media rack may include displaying each of the selectable objects relative to each other in the virtual media rack based at least in part on the respective locations of the corresponding physical objects in the physical storage apparatus. As an alternative or additional feature, in an exemplary embodiment operation 230 may include receiving an image of the physical storage apparatus and optically analyzing the image to determine configuration dimensions of the virtual media rack.

In an exemplary embodiment, determining whether the selectable object correlates to the digital content item may include determining whether the selectable object correlates to the digital content item stored in a location accessible to a device providing for the display. In some cases, determining whether the selectable object correlates to the digital content item may include analyzing an image of a portion of a physical storage apparatus including a physical object, generating the selectable object based on the physical object, identifying features associated with the physical object, and determining whether the features identified correlate with any of a plurality of digital content items.

In an exemplary embodiment, enabling the provision of information may include rendering the digital content item if the selectable object correlates to the digital content item stored in the location accessible to the device or providing indicia on the selectable object in which the indicia is indicative of a classification of the digital content item. In some cases, enabling the provision of information may include providing a user with information relating to enabling downloading of the digital content item if the selectable object does not correlate to a digital content item that is currently accessible to the device or providing a user with options with respect to viewing different portions of a virtual media rack in which the selectable object is disposed on the display. In this regard, for example, enabling the provision of information may include enabling the user to zoom in with respect to a portion of the virtual media rack by making a selection with respect to a portion of the display.

In an exemplary embodiment, an apparatus for performing the method of FIG. 7 above may comprise a processor (e.g., the processor 70) configured to perform each of the operations (200-230) described above. The processor may, for example, be configured to perform the operations (200-230) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200 to 230 may comprise, for example, the processor 70, respective ones of the feature extractor 78, the object generator 80, the object classifier 82, the object correlator 84 and the selection manager 86, or an algorithm executed by the processor for controlling image segmentation and analysis, media rack and selectable object formation and manipulation as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of a selectable object that is representative of a corresponding physical object associated with media content, the selectable object being arranged in the display based at least in part on a physical location of the physical object represented by the selectable object;
determining whether the selectable object correlates to a digital content item; and
enabling the provision of information corresponding to the digital content item in response to selection of the selectable object.

2. The method of claim 1, wherein determining whether the selectable object correlates to the digital content item comprises determining whether the selectable object correlates to the digital content item stored in a location accessible to a device providing for the display.

3. The method of claim 1, wherein determining whether the selectable object correlates to the digital content item comprises analyzing an image of a portion of a physical storage apparatus including a physical object; generating the selectable object based on the physical object; identifying features associated with the physical object; and determining whether the features identified correlate with any of a plurality of digital content items.

4. The method of claim 1, wherein enabling the provision of information comprises rendering the digital content item if the selectable object correlates to the digital content item stored in the location accessible to the device.

5. The method of claim 1, wherein enabling the provision of information comprises providing indicia on the selectable object in which the indicia is indicative of a classification of the digital content item.

6. The method of claim 1, wherein enabling the provision of information comprises providing a user with information relating to enabling downloading of the digital content item if the selectable object does not correlate to a digital content item that is currently accessible to the device.

7. The method of claim 1, wherein enabling the provision of information comprises providing a user with options with respect to viewing different portions of a virtual media rack in which the selectable object is disposed on the display.

8. The method of claim 7, wherein enabling the provision of information comprises enabling the user to zoom in with respect to a portion of the virtual media rack by making a selection with respect to a portion of the display.

9. The method of claim 1, further comprising constructing a virtual media rack corresponding to a physical storage apparatus in which the virtual media rack is configured based on attributes of the physical storage apparatus.

10. The method of claim 9, wherein the selectable object is one of a collection of selectable objects, each of the selectable objects associated with each respective one of a plurality of physical objects stored in the physical storage apparatus, and wherein constructing the virtual media rack comprises displaying each of the selectable objects relative to each other in the virtual media rack based at least in part on the respective locations of the corresponding physical objects in the physical storage apparatus.

11. The method of claim 9, wherein constructing the virtual media rack comprises receiving an image of the physical storage apparatus and optically analyzing the image to determine configuration dimensions of the virtual media rack.

12. An apparatus comprising a processor configured to:
provide for display of a selectable object that is representative of a corresponding physical object associated with media content, the selectable object being arranged in the display based at least in part on a physical location of the physical object represented by the selectable object;
determine whether the selectable object correlates to a digital content item; and
enable the provision of information corresponding to the digital content item in response to selection of the selectable object.

13. The apparatus of claim 12, wherein the processor is configured to determine whether the selectable object correlates to the digital content item by determining whether the selectable object correlates to the digital content item stored in a location accessible to a device providing for the display.

14. The apparatus of claim 12, wherein the processor is configured to determine whether the selectable object correlates to the digital content item by analyzing an image of a portion of a physical storage apparatus including a physical object; generating the selectable object based on the physical object; identifying features associated with the physical object; and determining whether the features identified correlate with any of a plurality of digital content items.

15. The apparatus of claim 12, wherein the processor is configured to enable the provision of information by rendering the digital content item if the selectable object correlates to the digital content item stored in the location accessible to the device.

16. The apparatus of claim 12, wherein the processor is configured to enable the provision of information by providing indicia on the selectable object in which the indicia is indicative of a classification of the digital content item.

17. The apparatus of claim 12, wherein the processor is configured to enable the provision of information by providing a user with information relating to enabling downloading of the digital content item if the selectable object does not correlate to a digital content item that is currently accessible to the device.

18. The apparatus of claim 12, wherein the processor is configured to enable the provision of information by providing a user with options with respect to viewing different portions of a virtual media rack in which the selectable object is disposed on the display.

19. The apparatus of claim 18, wherein the processor is configured to enable the provision of information by enabling the user to zoom in with respect to a portion of the virtual media rack by making a selection with respect to a portion of the display.

20. The apparatus of claim 12, wherein the processor is further configured to construct a virtual media rack corresponding to a physical storage apparatus in which the virtual media rack is configured based on attributes of the physical storage apparatus.

21. The apparatus of claim 20, wherein the selectable object is one of a collection of selectable objects, each of the selectable objects associated with each respective one of a plurality of physical objects stored in the physical storage apparatus, and wherein the processor is configured to construct the virtual media rack by displaying each of the selectable objects relative to each other in the virtual media rack based at least in part on the respective locations of the corresponding physical objects in the physical storage apparatus.

22. The apparatus of claim 20, wherein the processor is configured to construct the virtual media rack by receiving an image of the physical storage apparatus and optically analyzing the image to determine configuration dimensions of the virtual media rack.

23. A computer program product comprising at least one computer-readable storage medium having computer-executable program code instructions stored therein, the computer-executable program code instructions comprising:
first program code instructions for providing for display of a selectable object that is representative of a corresponding physical object associated with media content, the selectable object being arranged in the display based at least in part on a physical location of the physical object represented by the selectable object;
second program code instructions for determining whether the selectable object correlates to a digital content item; and
third program code instructions for enabling the provision of information corresponding to the digital content item in response to selection of the selectable object.

24. The computer program product of claim 23, wherein the second program code instructions include instructions for determining whether the selectable object correlates to the digital content item stored in a location accessible to a device providing for the display.

25. The computer program product of claim 23, wherein the second program code instructions include instructions for analyzing an image of a portion of a physical storage apparatus including a physical object; generating the selectable object based on the physical object; identifying features associated with the physical object; and determining whether the features identified correlate with any of a plurality of digital content items.

26. The computer program product of claim 23, wherein the third program code instructions include instructions for rendering the digital content item if the selectable object correlates to the digital content item stored in the location accessible to the device.

27. The computer program product of claim 23, wherein the third program code instructions include instructions for providing indicia on the selectable object in which the indicia is indicative of a classification of the digital content item.

28. The computer program product of claim 23, wherein the third program code instructions include instructions for providing a user with information relating to enabling downloading of the digital content item if the selectable object does not correlate to a digital content item that is currently accessible to the device.

29. The computer program product of claim 23, wherein the third program code instructions include instructions for providing a user with options with respect to viewing different portions of a virtual media rack in which the selectable object is disposed on the display.

30. The computer program product of claim 29, wherein the third program code instructions include instructions for enabling the user to zoom in with respect to a portion of the virtual media rack by making a selection with respect to a portion of the display.

31. The computer program product of claim 23, further comprising fourth program code instructions for constructing a virtual media rack corresponding to a physical storage apparatus in which the virtual media rack is configured based on attributes of the physical storage apparatus.

32. The computer program product of claim 31, wherein the selectable object is one of a collection of selectable objects, each of the selectable objects associated with each respective one of a plurality of physical objects stored in the physical storage apparatus, and wherein the fourth program code instructions include instructions for displaying each of the selectable objects relative to each other in the virtual media rack based at least in part on the respective locations of the corresponding physical objects in the physical storage apparatus.

33. The computer program product of claim 31, wherein the fourth program code instructions include instructions for receiving an image of the physical storage apparatus and optically analyzing the image to determine configuration dimensions of the virtual media rack.

34. An apparatus comprising a user interface element configured to:
display a selectable object that is representative of a corresponding physical object associated with media content, the selectable object being arranged in the display based at least in part on a physical location of the physical object represented by the selectable object;
receive an indication of a selection of the selectable object; and
provide information corresponding to the digital content item in response to the selection of the selectable object.
